(19) United States
(12) Patent Application Publication
(10) Pub. No.: US 2006/0041488 A1
(43) Pub. Date: Feb. 23, 2006

(54) Method and system for migrating messaging accounts between vendors

(76) Inventors: Michael O'Reirdon, Herndon, VA (US); John Kelley, Sicklerville, NJ (US)

Correspondence Address: BROOKS KUSHMAN P.C., 1000 TOWN CENTER, TWENTY-SECOND FLOOR, SOUTHFIELD, MI, 48075, US

(21) Appl. No.: 10/920,836

(22) Filed: Aug. 18, 2004

(51) Int. Cl. G07F 19/00; G07B 17/00

(52) U.S. Cl. 705/30

(57) ABSTRACT

A method and system for providing messaging services to subscribers. The services are provided such that message accounts can be migrated from one vendor to another. Service data relating to performance, costs, and other factors reflective of the vendors servicing of the messaging accounts is tracked and monitored for use in determining whether to migrate accounts from one vendor to another.

### BACKGROUND OF THE INVENTION

1. Field of the Invention

The present invention relates to migrating messaging accounts.

2. Background Art

A messaging account relates to a service that allows subscribers to send and receive messages, such as emails and voicemails. The messaging accounts are typically offered by entities that provide telephone or computer services to a number of subscribers, such as telephone companies and cable companies.

The entities offering the messaging accounts may out-source the support and infrastructure for servicing the accounts to vendors. With respect to email messaging, for example, some internet service providers (ISPs) out-source email messaging to vendors in order to off-load the administrative and technical support required to service the accounts and/or to simply take advantage of the ability of some vendors to support the messaging accounts at a lower cost.

Many vendors have proprietary systems and protocols that make it difficult and expensive to migrate messaging accounts from one vendor to another. The different protocols, in effect, make it difficult to migrate the messaging accounts without some interruption in service or costly software patch. This can be problematic to the entity out-sourcing the accounts because the out-sourcing entity may desire to migrate the accounts allocated to a particular vendor to another vendor because of poor performance. In the past, the out-sourcing entity was limited by the cost and interruption to service required to migrate the accounts to another vendor.

Accordingly, there exists a need for a cost-effective means for migrating messaging accounts from one vendor to another.

### SUMMARY OF THE INVENTION

It is, therefore, an object of the present invention to provide a system and method for providing messaging accounts that can be migrated from one vendor to another in a cost-effective manner.

Moreover, it is an object of the present invention to encourage market-based competition for the migration of the messaging accounts so that performance and cost effectiveness can be maximized.

One aspect of the present invention relates to a system having a gatekeeper in communication with at least two vendors, each vendor providing messaging accounts, such as email and voice mail accounts. The system is configured to permit the migration of accounts from one vendor to another and to maximize performance and cost effectiveness by forcing market-based competition for the allocation of the messaging accounts between the vendors.

In particular, the gatekeeper is interposed between subscribers of the messaging accounts and the vendors. The gatekeeper provides an interface therebetween to transmit and receive messaging signals between the vendors and subscribers. The gatekeeper can transmit messaging signals regardless of which vendor is responsible for maintaining and operating the subscriber's messaging accounts so that the messaging accounts can be allocated from one vendor to another as needed and without interruption in service.

In one aspect of the present invention, the gatekeeper includes a relay and a directory. The directory keeps track of which vendor is assigned to each subscriber. The directory instructs the relay as to which vendor is responsible for transmitting and receiving the messaging signals for a particular subscriber. In this manner, the subscriber can receive and transmit messaging signals to and from their respective vendor without knowing which vendor is actually acting on the signals. In effect, the messaging services are provided in a transparent manner to the subscribers.

One aspect of the present invention relates to encouraging market-based competition for the servicing of the messaging accounts. Preferably, the provider continuously, competitively evaluates the messaging services provided by each vendor on both a cost and performance basis.

Market-based competition can be encouraged by forcing two or more vendors to operate under common protocols so that the messaging accounts can be freely migrated from one vendor to another, and if necessary, back to the original vendor. To facilitate the migration of the messaging accounts, the gatekeeper can be configured to track which vendor is maintaining the messaging accounts and to coordinate the migration of the messaging accounts between the vendors.

After an initial allocation of messaging accounts to each vendor, services data is collected for each vendor to evaluate their cost and/or performance. Rating values are calculated in a computer based on the services data and are used to evaluate the cost and performance of the vendors. The evaluation provides a basis for directing a migration of the messaging accounts from one vendor to another as needed to maximize performance and cost effectiveness.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a system for providing messaging services in accordance with the present invention; and

FIG. 2 illustrates a flowchart of a method for providing messaging services in accordance with the present invention.

### DETAILED DESCRIPTION OF THE PREFERRED EMBODIMENT(S)

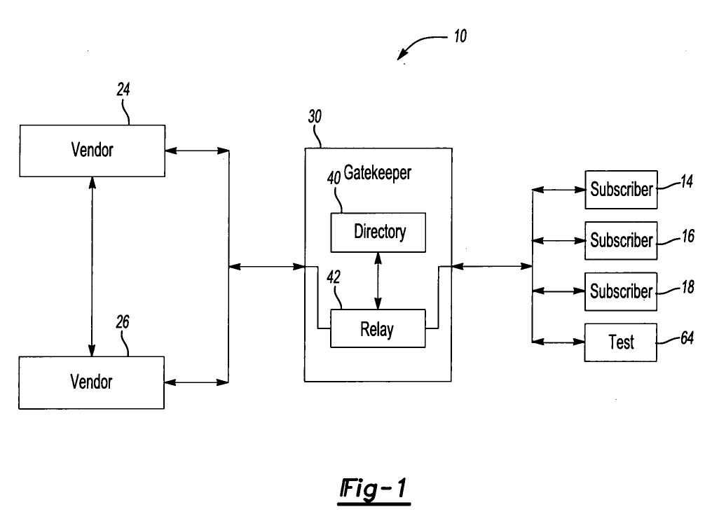

FIG. 1 illustrates system 10 for providing messaging accounts in accordance with one aspect of the present invention. The system 10 is particularly suited to cable service providers and other providers who desire to provide messaging services, such as email and/or voicemail. The provider can establish a relationship with a plurality of subscribers 14, 16 and 18 and use two or more vendors 24 and 26 to support the messaging accounts.

The vendors 24 and 26 support the messaging accounts by providing the services related thereto. An email vendor includes infrastructures and services for supporting email messaging so that emails can be sent and received by the subscriber 14, 16 and 18. A voicemail vendor includes similar capabilities for sending and receiving voice messages. The vendors 24 and 26 can include servers, memories, processors, and other devices to perform some or all of its support services. The present invention contemplates any configuration for the vendors 24 and 26, and particularly that the vendors 24 and 26 include communication means for communication over the Internet or similar hard-wire or wireless networks.

A gatekeeper 30 is configured as an interface between the subscribers 14, 16, and 18 and the vendors 24 and 26. The gatekeeper 30 is preferably supported by a provider of the messaging services. For example, if the provider is a cable service provider, gatekeeper 30 may provide a webpage or other accessible database that allows subscribers 14, 16, and 18 to login to their respective messaging accounts. The login page preferably includes indicia and other information of the provider so that the data transmitted between the subscribers 14, 16, and 18 and the vendors 24 and 26 appears to be pass through the provider. Once logged in, the gatekeeper 30 directs signals to and from vendors 24 and 26 as needed to service the logged-in subscriber.

The gatekeeper 30 can be a server or other interactive medium that interacts with the subscribers 14, 16 and 18 and the vendors 24 and 26 such that signals can be transferred back and forth between the vendors 24 and 26 and the subscribers 14, 16, and 18 in a manner that is transparent to the subscribers 14, 16 and 18. The gatekeeper 30 can transmit and receive messaging signals regardless of which vendor 24 or 26 is responsible for maintaining and operating the messaging account.

The gatekeeper 30 can include a relay 42 and a directory 40 to facilitate the tracking and coordinating of the signal between the vendors 24 and 26 and the subscribers 14, 16 and 18. The directory 40 keeps track of which vendor is assigned to each subscriber 14, 16, and 18 and the relay 42 relays the messaging signals between the vendors 24 and 26 and the subscribers 14, 16, and 18. In this manner, the subscribers 14, 16 and 18 can receive and transmit messages to and from their respective vendor 24 or 26 without knowing which vendor is actually servicing the messages.

If one of the subscribers 14, 16, and 18 desires to check their in-box for messages, for example, the gatekeeper 30 receives a corresponding signal from the subscriber 14, 16, and 18, which includes an identification for the requesting subscriber 14, 16, and 18. The relay 42 consults the directory 40 to identify which vendor 24 or 26 is servicing the identified subscriber and transmits the request to check the in-box to the appropriate vendor, for example, vendor 24. The vendor 24 performs the tasks necessary to determine the messages in the in-box of the subscriber 18 and to transmit the corresponding signals back to the relay 42 for ultimate delivery to the subscriber 18. Preferably, the relay 42 includes an identification number or other characteristic of the subscriber with the signals sent to the vendor 24 such that when the vendor 24 responds to the relay 42, the relay 42 can identify the corresponding subscriber without having to communicate with the directory 40. Due to the volume of data being transmitted or for other reasons, it may not be possible to do so, whereby the relay 42 may need to communicate with the directory 40 a second time to determine which subscriber 14, 16 or 18 is to receive the signals coming from the vendor 24.

In accordance with an aspect of the present invention, the gatekeeper 30 can control a migration of messaging accounts between the vendors 24 and 26 and/or other vendors. The ability to migrate messaging accounts between vendors 24 and 26 can be advantageous as it allows the provider to change vendors after an initial allocation of messaging accounts. Preferably, the migration can be done in a cost-effective manner and without interruption in services.

To facilitate the migration of email accounts between the vendors 24 and 26, the vendors 24 and 26 can be required to operate on the same or similar protocol. In this manner, a standard language can be established so that the data transferred from one vendor to another is understood by the receiving party. To migrate the messaging accounts, for example, from the vendor 24 to the vendor 26, the gatekeeper 30 sends a signal to one or both of the vendors 24 and 26 with instructions to migrate the identified accounts from the vendor 24 to the vendor 26. The instructions can direct the vendors 24 to migrate the accounts directly to the vendor 26 by transmitting the corresponding data over the Internet or other communication medium to the vendor 26 or indirectly by transmitting the corresponding data to the gatekeeper 30 for the gatekeeper 30 to then transfer to the vendor 26.

Once the migration is completed, the vendor 26 preferably transmits a confirmation signal to the relay 42 so that the relay 42 can update the directory 40 with the current location of the messaging account. In this manner, messaging accounts can be migrated between the vendors 24 and 26 with minimal, if any interaction or cost to the provider, other than merely receiving a signal for updating its directory 40. The vendor 24 can maintain some or all of the migrated data for subsequent servicing of the account, i.e. in case the account is migrated back to the vendor 24 at a later time.

The present invention contemplates that the gatekeeper 30 may include any number of features and components, in addition to the directory 40 and relay 42. Particularly, the gatekeeper 30 may include any number of secondary devices, such as personal computers and the like that interact with the gatekeeper 30 to control the operation thereof, such as by inputting and receiving information to and from the gatekeeper 30. It is contemplated that a decision to migrate the messaging accounts may need some human interaction, such that the gatekeeper 30 may need to be configured to output information to an analyst and to receive an input from the analyst indicating a determination of whether to migrate the messaging accounts, which the gatekeeper 30 can then receive for directing the migration of messaging accounts.

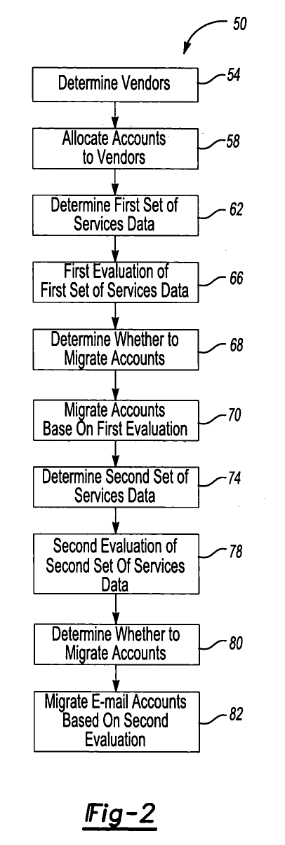

FIG. 2 illustrates a flowchart 50 of a method for providing messaging services in accordance with one aspect of the present invention. The method encourages market-based competition for allocating messaging accounts between the vendors to maximize cost effectiveness and performance.

Block 54 relates to determining the vendors. This process can include negotiating with a number of vendors to select two or more vendors that meet the provider's cost and performance targets. The vendors can be determined based on any number of features and criteria. The present invention is not intended to be limited by the manner in which the vendors are selected.

Block 58 relates to allocating messaging accounts to each vendor selected from a portion of the accounts serviced by the provider. The portion of the accounts allocated to each vendor can vary according to any number of factors, and preferably at least contemplates cost, vendor capacity, services provided by the vendor compared with services desired by the subscriber, and others.

Block 62 relates to determining a first set of services data for each vendor allocated messaging accounts. The services data generally relates to various metrics used to track the services provided by the vendors, such as performance, cost, customer satisfaction, and the like. In addition, other factors can be used, such as a capacity of one or more of the vendors, a discount rate offered by the vendor, and/or technological advancements provided by the vendor. The services data can be determined in a number ways, including surveys, testing, and others. For example, the vendors can be required to provide financial statements regarding their current cost structure for servicing the accounts and/or the vendors can be required to provide performance information related to response time in retrieving and transmitting messages, memory capacities, usage rates, down-time, types of email services provided, and the like. Of course, any number of parameters and cost/performance metrics can be used to generate the services data.

In accordance with one aspect of the present invention, a test subscriber 64 (see FIG. 1) is provided for use in determining the services data by testing the performance levels of vendors. Generally, this comprises the gatekeeper 30 prompting the test subscriber 64 to transmit a test signal that requests one or more of the vendors to take action so that a response of the vendor can be recorded by the gatekeeper 30. The gatekeeper 30 can then keep track of the performance for subsequent evaluation. The test signals can include any number of requests and prompts to test for any number of performance criteria.

The services data can be communicated to the gatekeeper 30 in a electronic medium, such as in a spreadsheet. Preferably, the services data is electronically received, stored, and processed by the gatekeeper 30 so that the gatekeeper 30 can perform electronic computations and other computer-implemented analysis of the services data. A computer or other processing means can be included as part of the gatekeeper 30 or as a separate device which communicates with gatekeeper 30 to store the services data and to perform computations related thereto.

Block 66 relates to a first evaluation of the first set of services data. This evaluation generally relates to processing the services data to compute different performance metrics for each vendor that can be used by the gatekeeper 30 to automatically evaluate the vendors. Alternatively, or in addition to, the gatekeeper 30 can be configured to output data, such as in printouts or computer files, that can be used by an analyst to evaluate the vendors.

The evaluation of block 66 can comprise any number of inquiries and computations, and at least preferably includes the gatekeeper 30 or other computer in communication therewith calculating rating values for the vendors. The ratings values are preferably based at least in part on the services data determined for the vendors. For example, the gatekeeper 30 can determine the rating values by assigning weighted values to different performance and cost criteria associated with the services data, such as by providing a higher weight for costs as opposed to other criteria. Based on the weighting and cost/performance for each vendor, the gatekeeper 30 can determine rating values for a number of evaluative metrics that can be used for differentiating between the vendors.

The gatekeeper 30 is preferably at least configured to calculate a difference in rating values between the vendors, and optionally other vendors not previously allocated any messaging accounts, to determine the best vendor or vendors for servicing the accounts, such as by determining the best vendor based on costs, the best vendor based on performance, the best vendor based on technological advancement/upgradablity, and/or some other combination of calculatable values. The gatekeeper 30 can include logic, fuzzy-logic, and/or neural networks for evaluating the services data based on the ratings values determined from the services data or other interpretations thereof. Likewise, an analyst can perform the evaluation based on the services data, the rating values, or other factors. The analyst can receive this information from the gateway 30 and/or from other resources. The gatekeeper 30 or the computer operated by the analyst can output a spreadsheet or other item for quantifying and categorizing the evaluations, such as by populating a number of fields in an evaluation checklist or report. Preferably, such an output is correlated to the services data to provide a measure of quantifying the relative performance of each vendor.

Block 68 relates to determining whether to migrate the messaging accounts from one vendor to another based on the evaluation of block 66. The migration generally relates to changing the allocation of messaging accounts so that one or more of the vendors is allocated more or less accounts from the accounts previously allocated to the vendors. For example, the migration can correspond with migrating accounts from the vendor 24 to the vendor 26 or another vendor.

The determination of whether to migrate the messaging accounts is based on the data outputted from the gateway 30 or compiled by the analyst in the evaluation block 66. The decision to migrate the messaging accounts can be made by the gateway 30, such as with a program embedded thereon that manipulates the evaluation according to predefined migration criteria and/or by the analyst inputting a migrating signal to the gateway 30 for instructing the gateway 30 to direct the migration based on the analyst's interpretation of the evaluation. Of course, the system and method relates to determining if the messaging accounts should be migrated, and may determine that the migration is inappropriate, i.e., that no migration is warranted.

The step of block 70 occurs after the messaging accounts have been allocated in block 58 and after services data has been collected in block 66 such that the present invention is able to track and monitor performance of the vendors and to direct the vendors to migrate messaging accounts, as needed, if cost and/or performance become unacceptable to the provider. This arrangement encourages market-based competition whereby the cost and performance of each vendor is monitored against the competition such that the vendors can potentially lose accounts if their cost/performance is low or potentially gain accounts if their cost/performance is high.

The foregoing method can be repeated as often as desired to further optimize the allocation of email accounts between vendors. For example, block 74 relates to determining a second set of services data after the migration in an effort to continue monitoring the vendors. The second set of services data can be collected as described above and used to represent the costs and performances of the vendors currently supporting messaging accounts and other vendors not currently supporting messaging accounts after the first migration of messaging accounts in block 70.

Such subsequent analysis can be advantageous as it allows a vendor which lost messaging accounts to perform better in the future and to regain the lost accounts, and in some cases, to add accounts. Such an iterative process facilitates competition as the vendors realize that business can be recaptured again in the future. Likewise, the iterative process encourage the vendors to provide continuous improvement and attention to quality control as the business gained by the vendor may be lost in subsequent migrations.

Preferably, the migration of the messaging accounts can be limited so that the vendors always have at least some accounts to be serviced. This can foster continued competition for the accounts as the vendors may be more likely to strive for better performance and costs if they are still servicing some of the accounts with the hope of gaining accounts in the future, even if they are currently servicing less accounts than they might have been at a previous time.

Block 78 relates to a second evaluation of the second set of services data. This evaluation generally comprises the gatekeeper 30 processing the services data as described above in block 66. Because this is the second evaluation, the evaluation can be further tailored to reflect the previous migration, if any.

Block 80 relates to determining whether to migrate the messaging accounts based on the evaluation of block 78. The determination is made in a manner similar to the described above in block 68, and it can further include consideration for a previous migration. For example, if the vendor 24 previously lost accounts due to poor performance, the vendor 24 may be restricted further if the poor performance is not corrected by the second evaluation at block 78, which can occur at any desired time after the first evaluation. Alternatively, the vendor 24 may not have previously lost accounts, but instead the vendor 24 may have been given a warning for poor performance. The second evaluation could then be used to determine whether the vendor 24 took the necessary corrective action. If not, then the vendor 24 may lose some or all of the accounts.

Still further, a weighting or sliding scale structure can be set up for each subsequent evaluation such that penalty and/or bonus rates can be increased and/or decreased based on past performance. If the vendor's performance continues to slide, the vendor may receive sharper cuts to their accounts than they would otherwise received if it were the first or second time the vendor failed to improve performance. Likewise, bonus rates, i.e., the awarding of more accounts, can be increased as the vendor reaches performance improvements. For example, the provider can establish a program where vendors who provide technological updates by predefined dates receive increased account volumes. This can prompt the vendors to provide more research and development and to spend more money on improvements and upgrades.

Block 82 relates to migrating the messaging accounts as described above and based on the second evaluation in block 78. This can include migration back some of the accounts lost by any of the vendors, or further debiting accounts from the vendors. It is understood that the steps of receiving the services data 62, 74, evaluating services data 66, 78, and determining the migration of messaging accounts 70, 82 can be repeated as often as desired to optimize the allocation of messaging accounts between vendors.

As described above, the system 10 provides messaging services in a manner such that messaging accounts can be migrated from one vendor to another, and flowchart 50 provides a method for migrating the messaging accounts so that performance and cost effectiveness can be maximized.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer-implemented method for determining an allocation of messaging accounts between multiple vendors, the method comprising:
allocating a plurality of messaging accounts to at least a first and second vendor;
determining services data regarding services provided by the first and second vendors after the initial allocation of the accounts;
calculating in a computer a rating value for each vendor based on the services data;
evaluating the rating values of each vendor; and
determining whether to migrate at least a portion of the messaging accounts initially allocated to one of the first and second vendors to at least one of the other of the first and second vendors and another vendor based on the evaluation of the rating values.

2. The method of claim 1 further comprising migrating at least a portion of the accounts allocated to one of the first and second vendors to at least one of the other of the first and second vendors and another vendor based on determining to migrate the messaging accounts.

3. The method of claim 2 further comprising receiving a second set of services data regarding the services provided by the vendors after migrating the messaging accounts to at least one of the other of the first and second vendors and another vendor, calculating in the computer a second set of rating values for each vendor based on the second set of services data, and evaluating the second set of rating values to determine whether to further allocate of the messaging accounts.

4. The method of claim 3 further comprising migrating at least a portion of the accounts allocated to one of the first and second vendors and another vendor to at least one of the other of the first and second vendors and another vendor based on the evaluation of the second set of rating values.

5. The method of claim 2 further comprising facilitating the migration of the messaging accounts by requiring each vendor to operate the messaging accounts according to a predefined protocol.

6. The method of claim 2 wherein the messaging accounts are migrated in a manner transparent to a user.

7. The method of claim 2 wherein migrating the messaging accounts includes the gatekeeper electronically sending a signal to the vendors to direct the vendors to migrate the messaging accounts.

8. The method of claim 1 wherein determining services data includes the gatekeeper electronically receiving a financial statement from each vendor regarding the services provided by each vendor, the financial statements for use in evaluating the cost effectiveness of the vendors.

9. The method of claim 8 wherein determining whether to migrate the messaging accounts is determined based in part on determining a most cost effective vendor.

10. The method of claim 1 wherein receiving services data includes sending test messages to the vendors and recording a response of the vendors to the test messages.

11. The method of claim 1 wherein allocating the messaging accounts includes allocating email accounts.

12. The method of claim 1 wherein allocating the messaging accounts includes allocating voicemail accounts.

13. The method of claim 1 wherein evaluating the rating values includes the computer calculating a difference in rating values between the first and second vendors.

14. The method of claim 1 wherein evaluating the rating values includes evaluating past rating values for the first and second vendors.

15. The method of claim 14 wherein evaluating the past rating values includes penalizing any vendor having consecutive decreases in rating values.

16. The method of claim 14 wherein evaluating the past rating values including providing a bonus to any vendor having consecutive increases in rating values.

17. The method of claim 1 wherein determining whether to migrate the messaging accounts includes determining if any vendor has performed technological upgrades.

18. The method of claim 1 further comprising issuing a warning to any vendor based on the evaluation of the rating values.

19. The method of claim 1 further comprising updating and evaluating the services data on a monthly basis such that the messaging accounts can be migrated on a monthly basis if needed.

20. A system for providing messaging services to subscribers, the system comprising:
at least first and second vendors having messaging servers for hosting messaging accounts; and
a gatekeeper in electrical communication with the vendors and operable to interface the subscribers to one or more of the vendors having the subscriber's messaging account, wherein the gatekeeper is operable to direct a migration of messaging accounts between the vendors.

21. The system of claim 20 wherein the gatekeeper is configured to receive services data regarding messaging services provided by the vendors after an initial allocation of messaging accounts to the vendors and to automatically determine whether to migrate at least a portion of the messaging accounts initially allocated to one of the first and second vendors to at least one of the other of the first and second vendors and another vendor based on the gatekeeper evaluating the services data.

22. The system of claim 20 wherein the gatekeeper is configured to receive services data regarding messaging services provided by the vendors after an initial allocation of messaging accounts to the vendors and to automatically output an evaluation of the services data for use by an analyst in determining whether to migrate at least a portion of the messaging accounts initially allocated to one of the first and second vendors to at least one of the other of the first and second vendors and another vendor based on the evaluation, whereby the analyst provides an input to the gatekeeper to direct the gatekeeper to migrate the messaging accounts.

23. The system of claim 20 wherein the gatekeeper outputs signals to the vendors for directing the migration of messaging accounts between the vendors.

24. The system of claim 20 wherein the vendors are configured to migrate messaging accounts directly to each other by electrically transferring data over a communication medium.

25. The system of claim 20 wherein the vendors are configured to migrate messaging accounts indirectly to each other by electrically transferring data over a communication medium to the gatekeeper, whereby the gatekeeper then transfers the data to the other vendors.

26. The system of claim 20 wherein the gatekeeper includes a directory and a relay, the directory operable to track the vendor allocated to each subscriber and the relay operable based on instructions from the directory to interface between the subscriber and the vendor allocated to the subscriber.

27. The system of claim 20 wherein the messaging accounts are email accounts.

28. The system of claim 20 wherein the messaging accounts are voicemail accounts.

29. A method for providing messaging accounts, the method comprising:
allocating a plurality of messaging accounts to a plurality of vendors;
evaluating services data based on at least one of performance and cost of the vendors such that the vendors are encouraged to compete for continued servicing of the messaging accounts allocated thereto; and
migrating at least a portion of the accounts initially allocated to one vendor to another vendor based on the evaluation of the services data.

30. The method of claim 29 wherein the vendors utilize a common protocol for servicing the messaging accounts so that the messaging accounts can be migrated in a cost-effective manner.

31. The method of claim 29 further comprising relaying messaging signals from the subscribers through a gatekeeper to the vendor allocated to the subscriber.

32. The method of claim 29 further comprising operating a directory of the gatekeeper to track the vendor allocated to each subscriber and operating a relay of the gatekeeper based on instructions from the directory to relay signals between the subscriber and the vendor allocated to the subscriber.

33. The system of claim 32 further comprising issuing signals from the gatekeeper to one or more vendors to migrate accounts to another vendor, whereby the gatekeeper updates the directory to control the relay to interface subscribers whose messaging accounts have been migrated to the appropriate vendor.
